(19) United States
(12) Patent Application Publication
(10) Pub. No.: US 2013/0035188 A1
(43) Pub. Date: Feb. 7, 2013

(54) HYBRID DRIVE APPARATUS

(71) Applicant: Toru Yagasaki, Wako-shi (JP)

(72) Inventor: Toru Yagasaki, Wako-shi (JP)

(73) Assignee: HONDA MOTOR CO., LTD., Tokyo (JP)

(21) Appl. No.: 13/538,011

(22) Filed: Jun. 29, 2012

(30) Foreign Application Priority Data
Aug. 2, 2011 (JP) 2011-169679

(51) Int. Cl. F16H 3/72; F16H 9/04

(52) U.S. Cl. 475/5; 903/902; 180/65.22

(57) ABSTRACT

In a hybrid drive apparatus having an engine, a motor generator, and a planetary gear mechanism in which the output shaft of the motor generator is coupled to a sun gear, the output shaft of the engine is coupled to a ring gear, and the input shaft of a continuously variable transmission mechanism is coupled to a carrier, the hybrid drive apparatus includes a first clutch that can switch engagement/disengagement between the output shaft of the engine and the ring gear, a second clutch that can switch engagement/disengagement between the carrier and the ring gear, and a third clutch that can switch engagement/disengagement on the input shaft of the transmission mechanism. Consequently, the power transmission path for the driving force from the engine can be separated from the power transmission path between the motor generator and drive wheels, and various driving modes can be set while improving power transmission efficiency.

### CROSS REFERENCE TO RELATED APPLICATION

The present disclosure contains subject matter related to Japanese Patent Application No. 2011-169679 filed on Aug. 2, 2011, the entire contents of which are incorporated herein by reference.

### BACKGROUND OF THE INVENTION

1. Field of the Invention

The present invention relates to a hybrid drive apparatus including an engine that generates power by combustion of fuel, and a motor generator that functions as an electric motor and a generator.

2. Description of Related Art

In the related art, as set forth in, for example, Japanese Patent No. 3414059 (Patent Document 1) and Japanese Patent No. 3458795 (Patent Document 2), there are hybrid drive apparatuses for a vehicle which include an engine that generates power by combustion of fuel, a motor generator that functions as an electric motor and a generator, a planetary gear mechanism that is capable of combining and outputting driving forces input from the engine and the motor generator, and a transmission mechanism that is capable of outputting a rotation caused by a driving force from the planetary gear mechanism to the drive wheels while changing the speed of the rotation. In a hybrid drive apparatus disclosed in Patent Document 1, the output shaft of an engine is coupled to a ring gear of a planetary gear, the output shaft of a motor generator is coupled to a sun gear, and a carrier as an output element is coupled to the input shaft of a continuously variable transmission (CVT). This hybrid drive apparatus is configured to control the rotational speed of the motor generator (in the charge and discharge directions) and also control the torque ratio of the continuously variable transmission while keeping the output of the engine at a predetermined value, thereby satisfying an output required by a vehicle.

As an improvement over the hybrid drive apparatus disclosed in Patent Document 1, there exists a hybrid drive apparatus disclosed in Patent Document 2. In the hybrid drive apparatus disclosed in Patent Document 2, the output shaft of an engine is coupled to the sun gear of a double pinion-type planetary gear mechanism, the output shaft of a motor is coupled to one carrier, the other carrier is coupled to the input shaft of a continuously variable transmission, a first clutch is provided between the other carrier and the input shaft of the continuously variable transmission, and a second clutch is provided between a ring gear and the input shaft of the continuously variable transmission.

However, in the hybrid drive apparatus disclosed in Patent Document 2, a mechanism such as a clutch for switching whether to transmit power is not provided between the output shaft of the engine and the sun gear of the planetary gear mechanism, and hence the output shaft of the engine and the sun gear of the planetary gear mechanism are directly coupled to each other. Therefore, when performing decelerating regeneration by the motor generator during deceleration of the vehicle, the power transmission path through which the driving force from the engine is transmitted cannot be separated from the power transmission path between the motor generator and drive wheels, and it is not possible to eliminate drag torque until the engine stops. As a result, it is not possible to perform efficient energy regeneration by the motor generator.

Also, in the hybrid drive apparatus disclosed in Patent Document 1, a clutch (second clutch) is provided between the sun gear and ring gear of the planetary gear mechanism. However, in the planetary gear mechanism of the hybrid drive apparatus configured as mentioned above, comparatively large relative velocity (differential rotation) between the sun gear and the ring gear causes large differential rotation (slipping velocity) of the friction material when the clutch is disengaged. Therefore, friction loss in the clutch affects the transmission efficiency of the hybrid drive apparatus.

### SUMMARY OF THE INVENTION

The invention has been made in view of the above-mentioned problems, and accordingly it is an object of the invention to provide a hybrid drive apparatus that enables efficient energy regeneration by the motor generator by separating the power transmission path through which the driving force from the engine is transmitted, from the power transmission path between the motor generator and the drive wheels, and also makes it possible to achieve a variety of driving modes while improving power transmission efficiency.

To address the above-mentioned problems, a hybrid drive apparatus according to the invention includes: an engine (10) that generates power by combustion of fuel, and has an output shaft (11); a motor generator (20) that functions as an electric motor and a generator, and has a rotating shaft (21); a planetary gear mechanism (30) that has three elements, the three elements including a sun gear (S), a ring gear (R), and a carrier (C); a transmission mechanism (40) that has a first rotating shaft (42) coupled to the planetary gear mechanism (30), and a second rotating shaft (44) connecting to a drive wheel (66, 66) side, the transmission mechanism (40) being configured to output a rotation input from one of the first rotating shaft (42) and the second rotating shaft (44) to the other one of the first rotating shaft (42) and the second rotating shaft (44) while changing a speed of the rotation, the rotating shaft (21) of the motor generator (20), the output shaft (11) of the engine (10), and the first rotating shaft (42) of the transmission mechanism (40) being coupled to the sun gear (S), the ring gear (R), and the carrier (C), respectively, of the planetary gear mechanism (30); a first clutch (C1) that can switch engagement/disengagement between the output shaft (11) of the engine (10) and the ring gear (R) of the planetary gear mechanism (30); and a second clutch (C2) that can switch engagement/disengagement between the carrier (C) and the ring gear (R) of the planetary gear mechanism (30), or between the carrier (C) and the sun gear (S).

The hybrid drive apparatus according to the invention includes the first clutch that can switch engagement/disengagement between the output shaft of the engine and the ring gear of the planetary gear mechanism. Thus, an input of driving force from the engine to the planetary gear mechanism can be cut off by means of the first clutch. As a result, when performing decelerating regeneration by the motor generator during deceleration of the vehicle, the power transmission path through which the driving force from the engine is transmitted can be separated from the power transmission path between the motor generator and the drive wheels. Therefore, the driving force of the engine input to the planetary gear mechanism during decelerating regeneration can be cut off, thus enabling efficient regeneration of decelerating energy by the motor generator.

Also, in the hybrid drive apparatus according to the invention, engaging the second clutch that is provided between the carrier and sun gear of the planetary gear mechanism or between the carrier and the ring gear enables the three elements (the sun gear, the ring gear, and the carrier) of the planetary gear mechanism to rotate integrally. As a result, mechanical power transmission loss in the planetary gear mechanism can be reduced. Therefore, the power from each of the engine and the motor generator can be transmitted more efficiently, and also decelerating energy can be regenerated more efficiently by the motor generator.

Also, in the hybrid drive apparatus according to the invention configured so that the rotating shaft of the motor generator is coupled to the sun gear of the planetary gear mechanism, the output shaft of the engine is coupled to the ring gear, and the first rotating shaft of the transmission mechanism is coupled to the carrier, the second clutch is provided between the carrier and ring gear, or between the carrier and the sun gear of the planetary gear mechanism. Thus, as compared with the hybrid drive apparatus according to the related art, the slipping velocity of the friction material in the second clutch that is in a disengaged state can be reduced, thereby improving power transmission efficiency.

That is, in the hybrid drive apparatus disclosed in Patent Document 1, a clutch is provided between the sun gear and the ring gear whose relative velocity is comparatively large, whereas in the hybrid drive apparatus according to the invention, the clutch (second clutch) is provided between the ring gear and the carrier or between the sun gear and the carrier whose relative velocity is comparatively small. As a result, the differential rotation (slipping velocity) of the friction material becomes small when the second clutch is in a disengaged state. Thus, friction loss in the second clutch can be reduced, thereby achieving a corresponding improvement in the transmission efficiency of the hybrid drive apparatus.

The above-mentioned hybrid drive apparatus according to the invention may further include a third clutch (C3, C3′) that can switch engagement/disengagement on the first rotating shaft (42) or the second rotating shaft (44). According to this configuration, by disengaging the third clutch, it is possible to cut off the power transmitted from the planetary gear mechanism to the drive wheels. Therefore, it is possible to charge a storage battery by disengaging the third clutch and using the driving force of the engine to generate electricity by the motor generator.

Also, in the hybrid drive apparatus according to the invention, the transmission mechanism (40) may be a belt-type continuously variable transmission mechanism (40), the belt-type continuously variable transmission mechanism (40) including a driving pulley (41) that connects to the first rotating shaft (42), a driven pulley (43) that connects to the second rotating shaft (44), and a belt (48) that is run between the driving pulley (41) and the driven pulley (43).

In that case, the third clutch (C3) maybe provided on the first rotating shaft (42) of the transmission mechanism (40). According to this configuration, by disengaging the third clutch, it is possible to limit the driving force (input torque) input to the belt-type continuously variable transmission mechanism from the planetary gear mechanism. As a result, functional compensation such as slip compensation of the belt-type continuously variable transmission mechanism is possible without complex control or estimation of the input torque to the belt-type continuously variable transmission mechanism.

Alternatively, the third clutch (C3) may be provided on the second rotating shaft (44) of the transmission mechanism (40). According to this configuration, by disengaging the third clutch, it is possible to cut off transmission of power from the continuously variable transmission mechanism to the drive wheels while keeping the continuously variable transmission mechanism rotated by the power transmitted from the planetary gear mechanism. As a result, the continuously variable transmission mechanism does not need to be controlled on the condition that the ratio (pulley ratio) of the continuously variable transmission mechanism at the time of cutting off transmission of power to the drive wheels can be returned to the ratio used at the time of resuming transmission of power to the drive wheels next time.

That is, it is possible to change the ratio of the continuously variable transmission mechanism even while transmission of power to the drive wheels is cut off by disengaging the third clutch. Thus, even if the ratio at the time of resuming transmission of power to the drive wheels next time is a low speed ratio for hill-climbing driving or decelerating regeneration, the ratio of the continuously variable transmission mechanism prior to cutting off transmission of power to the drive wheels can be set to an optimum ratio for the driving condition at that time. Therefore, it is possible to perform regeneration of decelerating energy or the like without affecting the drivability of the vehicle.

Also, it is unnecessary to supplement torque during low speed driving by the motor generator in order to return the ratio of the continuously variable transmission mechanism to a low speed ratio when resuming transmission of power to the drive wheels next time. Therefore, there is no need to secure spare capacity in the output of the motor generator in consideration of the need to supplement torque, and hence it is possible to use the motor generator with lower power and smaller size.

It is to be noted that the above symbols in parentheses each represent a symbol denoting the corresponding component in embodiments described later, as an example of the invention.

According to the invention, it is possible to provide a hybrid drive apparatus that enables efficient energy regeneration by the motor generator by separating the power transmission path through which the driving force from the engine is transmitted, from the power transmission path between the motor generator and the drive wheels when decelerating regeneration is performed by the motor generator during deceleration of the vehicle, and also makes it possible to set a variety of driving modes while improving power transmission efficiency.

### BRIEF DESCRIPTION OF THE DRAWINGS

FIG. 1 is a skeleton diagram illustrating the configuration of a hybrid drive apparatus according to a first embodiment of the invention;

FIG. 2 is a nomographic diagram illustrating the velocity relationship among various elements of a planetary gear mechanism;

FIG. 3 is a chart (table) for explaining the relationship among driving modes of the hybrid drive apparatus and operating states of clutches and brake;

FIGS. 4A to 4H are nomographic diagrams illustrating the velocity relationship among various elements of the planetary gear mechanism in each driving mode;

FIG. 5 is a skeleton diagram illustrating the configuration of a hybrid drive apparatus according to a second embodiment of the invention; and

FIG. 6 is a skeleton diagram illustrating the configuration of a hybrid drive apparatus according to a third embodiment of the invention.

### DETAILED DESCRIPTION OF EMBODIMENTS

Embodiments of the invention will be described in detail as below with reference to the accompanying drawings.

### First Embodiment

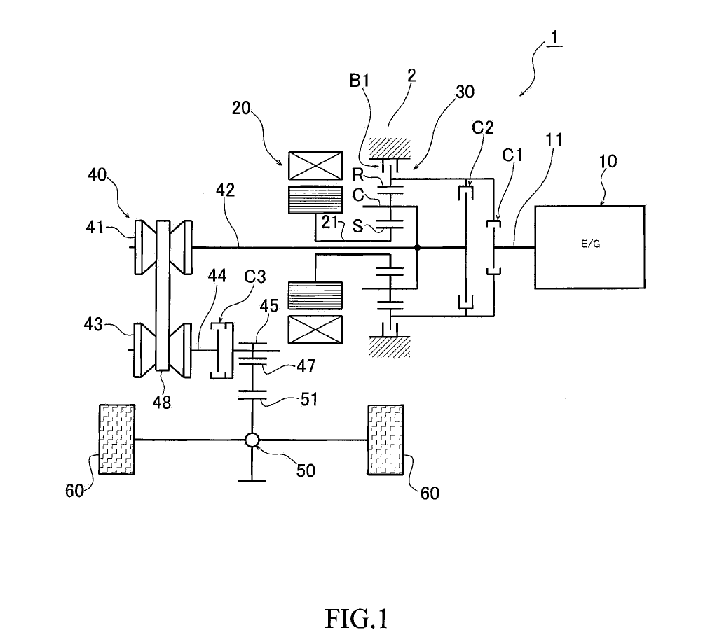

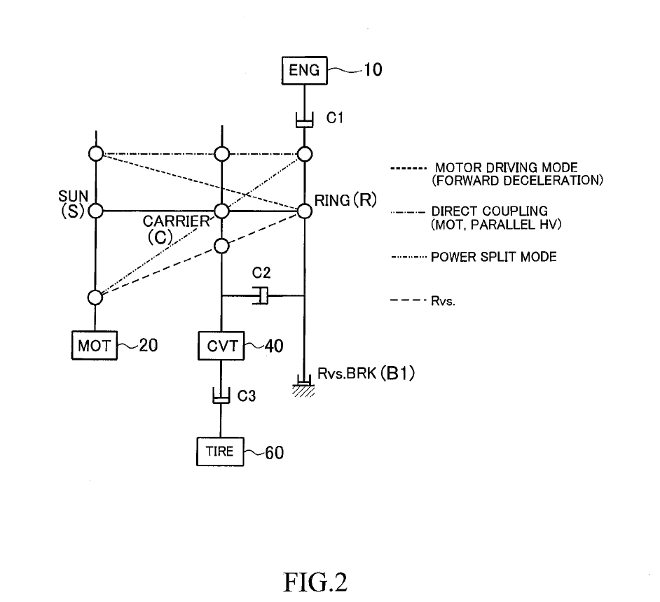

FIG. 1 is a skeleton diagram illustrating the configuration of a hybrid drive apparatus according to a first embodiment of the invention. Also, FIG. 2 is a nomographic diagram (velocity diagram) illustrating the velocity relationship among various elements of a planetary gear mechanism provided in the hybrid drive apparatus. A hybrid drive apparatus 1 illustrated in FIG. 1 includes an engine 10 that generates power by combustion of fuel, a motor generator 20 that functions as an electric motor and a generator, a single pinion-type planetary gear mechanism 30 having three elements, i.e., a sun gear S, a ring gear R, and a carrier C, and a belt-type continuously variable transmission mechanism 40 having a belt 48 that is run between a driving pulley 41 and a driven pulley 43.

An output shaft (rotating shaft) 21 of the motor generator 20 is coupled to the sun gear S of the planetary gear mechanism 30. An input shaft (first rotating shaft) 42 of the continuously variable transmission mechanism 40 which connects to the driving pulley 41 is coupled to the carrier C. Also, the ring gear R is coupled to the output shaft 11 of the engine 10 via a first clutch C1, and is also coupled to the input shaft 42 of the continuously variable transmission mechanism 40 via a second clutch C2. The ring gear R can be secured to a case (a member on the stationary side) 2 accommodating the hybrid driving mechanism 1 via a brake B1.

Further, an output gear 45 is provided on an output shaft (second rotating shaft) 44 of the continuously variable transmission mechanism 40 which connects to the driven pulley 43. The output gear 45 meshes with a counter gear 47. The counter gear 47 meshes with a ring gear 51 of a differential device 50. The differential device 50 is configured to distribute the driving force from the counter gear 47 between left and right drive wheels 60, 60. A third clutch C3 is provided on the output shaft 44 (between the driven pulley 43 and the output gear 45) of the continuously variable transmission mechanism 40.

That is, in the planetary gear mechanism 30 of the hybrid drive apparatus illustrated in FIG. 1, the sun gear S coupled to the output shaft 21 of the motor generator 20, and the ring gear R coupled to the output shaft 11 of the engine 10 each serve as an input member, and the carrier C coupled to the input shaft 42 of the continuously variable transmission mechanism 40 serves as an output member. The first clutch C1 is capable of switching engagement/disengagement between the output shaft 11 of the engine 10 and the ring gear R, and the second clutch C2 is capable of switching engagement/disengagement between the carrier C and the ring gear R. Also, the third clutch C3 is capable of switching whether or not to transmit driving force from the continuously variable transmission mechanism 40 to the drive wheels 60, 60. Although not illustrated in detail, a single disc or multi-disc hydraulic friction clutch that is frictionally engaged by means of a hydraulic actuator may be used for each of the first to third clutches C1 to C3 and the brake B1 mentioned above. Other kinds of clutches such as an electromagnetic clutch may be used as well.

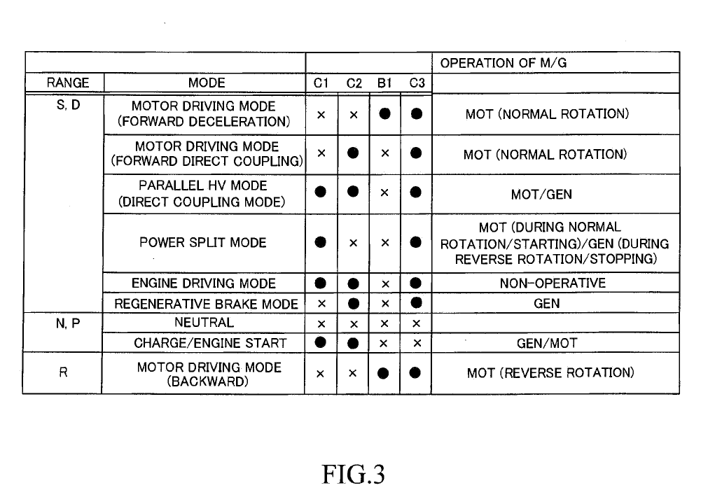

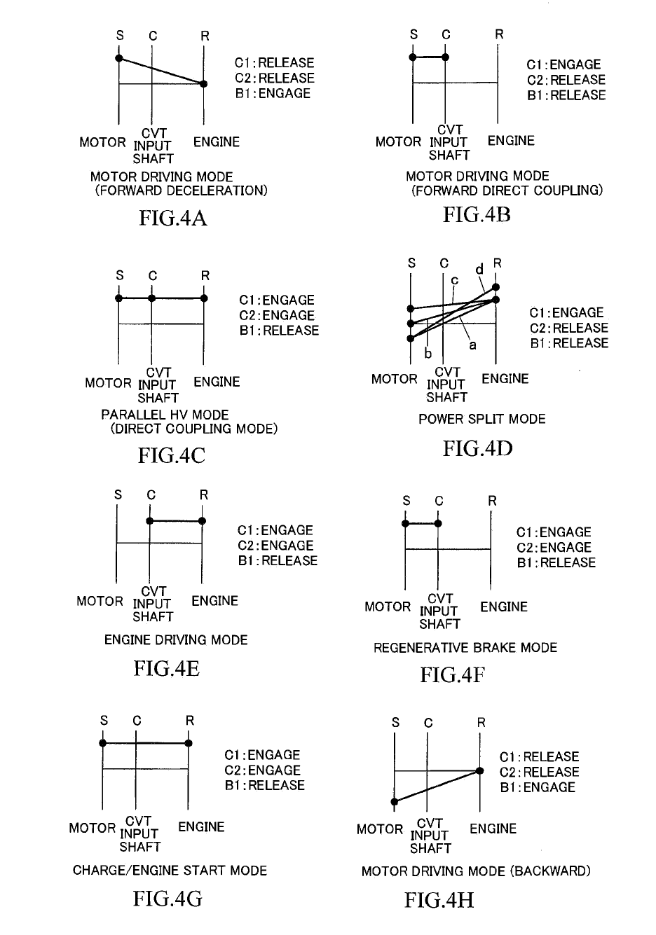

FIG. 3 is a chart (table) illustrating the relationship among driving modes of the hybrid drive apparatus 1 illustrated in FIG. 1, and operating states of the first to third clutches C1 to C3 and brake B1. FIGS. 4A to 4H are nomographic diagrams (velocity diagrams) illustrating the velocity relationship among various elements of the planetary gear mechanism 30 in each driving mode of the hybrid drive apparatus 1. In FIG. 3, the mark indicates engaged state of the corresponding clutch or brake, and the mark × indicates disengaged (releases) state. In the hybrid drive apparatus 1, the driving modes illustrated in the table of FIG. 3 are established in accordance with the operating states (engaged/disengaged) of the first to third clutches C1 to C3 and the brake B1. That is, when the transmission range is “S” or “D”, one of the following modes is established: “motor driving mode (forward deceleration)”; “motor driving mode (forward direct coupling)”; “parallel HV mode (direct coupling mode)”; “power split mode”; “engine driving mode”; and “regenerative brake mode”. When the transmission range is “N” or “P”, either “neutral” or “charge/engine start mode” is established. When the transmission range is “R”, “motor driving mode (backward)” is established. For the “S”, “D”, and “R” ranges, the third clutch C3 is engaged in all of these modes. For the “N” and “P” ranges, the third clutch C3 is disengaged (released) in all of these modes. The driving modes are described in detail below.

In the “motor driving mode (forward deceleration)”, the brake B1 is engaged, the first clutch C1 and the second clutch C2 are released, and in this state, the motor generator 20 is driven to rotate in the normal direction. As a result, the driving force of the motor generator 20 is transmitted to the drive wheels 60, 60 via the planetary gear mechanism 30 and the continuously variable transmission mechanism 40, thereby driving the vehicle forward by the driving force of the motor generator 20 alone. In this “motor driving mode (forward deceleration)”, as illustrated in the nomographic diagram of FIG. 4A, the ring gear R is locked by the engagement of the brake B1. Thus, the rotation of the output shaft 21 of the motor generator 20 input to the sun gear S is reduced as the rotation is output from the carrier C to the continuously variable transmission mechanism 40. In this way, in the hybrid drive apparatus 1 according to this embodiment, the rotation of the output shaft 21 of the motor generator 20 is reduced by means of the planetary gear mechanism 30 before being output. Therefore, in the “motor driving mode (forward deceleration)”, a large torque can be attained particularly during vehicle starting, without increasing the size of the motor generator 20.

In the “motor driving mode (forward direct coupling)”, the second clutch C2 is engaged, the first clutch C1 and the brake B1 are released, and in this state, the motor generator 20 is driven to rotate in the normal direction. As a result, the driving force of the motor generator 20 is transmitted to the drive wheels 60, 60 via the planetary gear mechanism 30 and the continuously variable transmission mechanism 40, thereby driving the vehicle forward by the driving force of the motor generator 20 alone. In this “motor driving mode (forward direct coupling)”, the engagement of the second clutch C2 causes the three elements of the planetary gear mechanism 30, i.e., the ring gear R, the carrier C, and the sun gear S to rotate integrally. Therefore, as illustrated in the velocity diagram of FIG. 4B, the rotation of the output shaft 21 of the motor generator 20 input to the sun gear S is output from the carrier C to the continuously variable transmission mechanism 40 while remaining at the same velocity. In this way, in the hybrid drive apparatus 1 according to this embodiment, the engagement of the second clutch C2 causes the components of the planetary gear mechanism 30, i.e., the ring gear R, the carrier C, and the sun gear S to rotate integrally. Therefore, in the “motor driving mode (forward direct coupling)”, it is possible to efficiently regenerate a large amount of energy during decelerating regeneration by the motor generator 20.

In the “parallel HV mode (direct coupling mode)”, the first clutch C1 and the second clutch C2 are engaged, the brake B1 is released, and in this state, the motor generator 20 is operated as an electric motor or a generator. In this “parallel HV mode (direct coupling mode)”, as illustrated in the nomographic diagram of FIG. 4C, the engagement of the second clutch C2 causes the three elements of the planetary gear mechanism 30, i.e., the ring gear R, the carrier C, and the sun gear S to rotate integrally. In the case of operating the motor generator 20 as an electric motor, the motor generator 20 is driven to rotate in the normal direction, which causes the driving force of the motor generator 20 and the driving force of the engine 10 which are combined in the planetary gear mechanism 30 to be transmitted to the drive wheels 60, 60 via the continuously variable transmission mechanism 40, thereby driving the vehicle forward. In the case of operating the motor generator 20 as a generator, as the rotation of the output shaft 11 of the engine 10 input to the ring gear R is output from the carrier C to the continuously variable transmission mechanism 40 while remaining at the same velocity, the vehicle drives forward, and the driving force transmitted to the output shaft 21 of the motor generator 20 at that time from the sun gear S that rotates integrally with the ring gear R is used to generate electricity by the motor generator 20.

In the “power split mode”, the first clutch C1 is engaged, the second clutch C2 and the brake B1 are released, and in this state, the motor generator 20 is driven to rotate in the normal and reverse directions. As a result, the driving force of the motor generator 20 and the driving force of the engine 10 which are combined in the planetary gear mechanism 30 are transmitted to the drive wheels 60, 60 via the continuously variable transmission mechanism 40, thereby driving the vehicle forward by both the driving force of the motor generator 20 and the driving force of the engine 10. In this “power split mode”, as illustrated in the nomographic diagram of FIG. 4D, a rotation that is reduced relative to the rotation of the output shaft 21 of the motor generator 20 and the rotation of the output shaft 11 of the engine 10 is output from the carrier C to the continuously variable transmission mechanism 40. That is, in the state indicated by the nomographic line denoted by symbol “a” in FIG. 4D, the ring gear R coupled to the output shaft 11 of the engine 10 is rotating in the normal direction, the rotation of the carrier C coupled to the input shaft 42 of the continuously variable transmission mechanism 40 is zero, and the vehicle is at a stop. At this time, the sun gear S coupled to the motor generator 20 is being driven to rotate in the reverse direction, and the motor generator 20 is generating electricity. In this state, when the motor generator 20 is controlled to reduce the amount of electricity generation, as indicated by the nomographic line denoted by symbol “b”, the rotation of the sun gear S approaches zero, and the rotation of the carrier C coupled to the input shaft 42 of the continuously variable transmission mechanism 40 gradually increases. Thereafter, as indicated by the nomographic line denoted by symbol “c”, the rotation of the sun gear S exceeds zero, that is, the motor generator 20 is operated as a motor to output torque, and the rotation of the carrier C is increased. As a result, it is possible for the vehicle to start smoothly from zero speed even without a starting device. It is also possible to start the vehicle from the vehicle stop state indicated by the nomographic line denoted by symbol “a”, by raising the driving force of the engine 10 and increasing the rotation of the ring gear R as indicated by the nomographic line denoted by symbol “d”.

In the “engine driving mode”, the first clutch C1 and the second clutch C2 are engaged, the brake B1 is released, and in this state, the motor generator 20 is rendered non-operative. As a result, the driving force of the engine 10 is transmitted to the drive wheels 60, 60 via the planetary gear mechanism 30 and the continuously variable transmission mechanism 40, thereby driving the vehicle forward by the driving force of the engine 10 alone. In this “engine driving mode”, the engagement of the second clutch C2 causes the three elements of the planetary gear mechanism 30, i.e., the ring gear R, the carrier C, and the sun gear S to rotate integrally. Therefore, as illustrated in the nomographic diagram of FIG. 4E, the rotation of the output shaft 11 of the engine 10 input to the ring gear R is output from the carrier C to the continuously variable transmission mechanism 40 while remaining at the same velocity. In the hybrid drive apparatus 1 according to this embodiment, the engagement of the second clutch C2 causes the components of the planetary gear mechanism 30, i.e., the ring gear R, the carrier C, and the sun gear S to rotate integrally. Therefore, in this “engine driving mode”, it is possible to efficiently transmit the output of the engine 10.

In the “regenerative brake mode”, the second clutch C2 is engaged, the first clutch C1 and the brake B1 are released, and in this state, the motor generator 20 is operated as a generator, thereby performing regenerative braking by the motor generator 20. In this “regenerative brake mode” as well, the engagement of the second clutch C2 causes the three elements of the planetary gear mechanism 30, i.e., the ring gear R, the carrier C, and the sun gear S to rotate integrally. Therefore, as illustrated in the nomographic diagram of FIG. 4F, the rotation of the input shaft 42 of the continuously variable transmission mechanism 40 input to the carrier C is output from the sun gear S to the output shaft 21 of the motor generator 20 while remaining at the same velocity. In this hybrid drive apparatus 1 according to this embodiment, the power transmission path through which the driving force from the engine 10 is transmitted can be separated by means of the first clutch C1 from the power transmission path between the motor generator 10 and the drive wheels 60, 60. As a result, it is possible to eliminate drag torque of the engine 10 input to the planetary gear mechanism 30 during decelerating regeneration, thus enabling efficient regeneration of energy by the motor generator 20.

In “neutral”, the third clutch C3 is released as described above, and further, the first and second clutches C1 and C2 and the brake B1 are all released. As a result, the power transmission path between the output shaft 11 of the engine 10 and the planetary gear mechanism 30, the power transmission path between the output shaft 11 of the engine 10 and the input shaft 42 of the continuously variable transmission mechanism 40, and the power transmission path from the continuously variable transmission mechanism 40 to the drive wheels 60, 60 become cut off.

In the “charge/engine start mode”, the third clutch C3 is released, and further, the first clutch C1 and the second clutch C2 are engaged and the brake B1 is released. In this state, the motor generator 20 is operated as an electric motor to start the engine 10, or the motor generator 20 is operated as a generator to perform electricity generation (charging) by the driving force of the engine 10. To start the engine 10, the rotation of the output shaft 21 of the motor generator 20 is transmitted to the output shaft 11 of the engine 10 by the planetary gear mechanism 30. Also, to generate electricity by the motor generator 20, the rotation of the output shaft 11 of the engine 10 is transmitted to the output shaft 21 of the motor generator 20 by the planetary gear mechanism 30 to rotationally drive the motor generator 20, thereby generating electricity to charge a capacitor (not illustrated) connected to the motor generator 20. In this “charge/engine start mode”, the engagement of the second clutch C2 causes the three elements of the planetary gear mechanism 30, i.e., the ring gear R, the carrier C, and the sun gear S to rotate integrally. Therefore, as illustrated in the nomographic diagram of FIG. 4G, a rotation input to one of these elements, i.e., the sun gear S, the carrier C, and the ring gear R is output to the other elements while remaining at the same velocity.

In the hybrid drive apparatus 1 according to this embodiment, the third clutch C3 is provided on the output shaft 44 of the continuously variable transmission mechanism 40. Thus, by disengaging the third clutch C3, the power transmitted from the continuously variable transmission mechanism 40 to the drive wheels 60, 60 can be cut off. Therefore, it is possible to charge a storage battery by disengaging the third clutch C3 as described above, and using the driving force of the engine 10 to generate electricity by the motor generator 20.

In the “motor driving mode (backward)”, the brake B1 is engaged, the first clutch C1 and the second clutch C2 are released, and in this state, the motor generator 20 is driven to rotate in the reverse direction. As a result, the vehicle is driven backward by the driving force of the motor generator 20. In this “motor driving mode (backward)”, the ring gear R is locked by the brake B1. Thus, as illustrated in the nomographic diagram of FIG. 4H, the rotation (reverse rotation) of the output shaft 21 of the motor generator 20 input to the sun gear S is reduced as the rotation is output from the carrier C to the continuously variable transmission mechanism 40.

As described above, the hybrid drive apparatus 1 according to this embodiment includes the engine 10 that generates power by combustion of fuel, the motor generator 20 that functions as an electric motor and a generator, the planetary gear mechanism 30 that has three elements, i.e., the sun gear S, the ring gear R, and the carrier C, and the continuously variable transmission mechanism 40 that can output a rotation caused by the driving force from the planetary gear mechanism 30 to the drive wheels 60, 60 while changing the speed of the rotation. The output shaft 21 of the motor generator 20 is coupled to the sun gear S of the planetary gear mechanism 30, the output shaft 11 of the engine 10 is coupled to the ring gear R, and the input shaft 42 of the continuously variable transmission mechanism 40 is coupled to the carrier C. Further, the hybrid drive apparatus 1 according to this embodiment includes the first clutch C1 that can switch engagement/disengagement between the output shaft 11 of the engine 10 and the ring gear R, the second clutch C2 that can switch engagement/disengagement between the carrier C and the ring gear R, and the third clutch C3 that is provided on the output shaft 44 of the continuously variable transmission mechanism 40.

The hybrid drive apparatus 1 according to this embodiment includes the first clutch C1 that can switch engagement/disengagement between the output shaft 11 of the engine 10 and the ring gear R. Thus, an input of driving force from the engine 10 to the planetary gear mechanism 30 can be cut off by means of the first clutch C1. As a result, the power transmission path through which the driving force from the engine 10 is transmitted can be separated from the power transmission path between the motor generator 20 and the drive wheels 60, 60. Therefore, when performing decelerating regeneration during deceleration of the vehicle, the driving force of the engine 10 input to the planetary gear mechanism 30 can be cut off, thus enabling efficient regeneration of decelerating energy by the motor generator 20.

In the hybrid drive apparatus 1 according to this embodiment, engaging the second clutch C2 provided between the carrier C and ring gear R of the planetary gear mechanism 30 causes the three elements (the ring gear R, the sun gear S, and the carrier C) of the planetary gear mechanism 30 to rotate integrally. As a result, mechanical power transmission loss in the planetary gear mechanism 30 can be reduced. Therefore, the power from each of the engine 10 and the motor generator 20 can be transmitted more efficiently, and also decelerating energy can be regenerated by the motor generator 20 more efficiently.

Also, the hybrid drive apparatus 1 according to this embodiment includes the second clutch C2 that is provided between the carrier C and ring gear R of the planetary gear mechanism 30. Thus, as compared with a clutch in the hybrid drive apparatus according to the related art which is provided between the ring gear and the sun gear, the slipping velocity of the friction material in the second clutch C2 that is in a disengaged state can be reduced, thereby improving power transmission efficiency. That is, in the hybrid drive apparatus disclosed in Patent Document 1, a clutch is provided between the sun gear and the ring gear whose relative velocity is comparatively large, whereas in the hybrid drive apparatus 1 according to this embodiment, the second clutch C2 is provided between the ring gear R and the carrier C whose relative velocity is comparatively small. As a result, the differential rotation (slipping velocity) of the friction material becomes small when the second clutch C2 is in a disengaged state. Thus, friction loss in the second clutch C2 can be reduced, thereby achieving a corresponding improvement in the transmission efficiency of the hybrid drive apparatus 1.

Also, in the hybrid drive apparatus 1 according to this embodiment, the third clutch C3 is provided on the output shaft 44 of the continuously variable transmission mechanism 40. Thus, by disengaging (releasing) the third clutch C3, it is possible to cut off the power transmitted from the planetary gear mechanism 30 to the drive wheels 60, 60. Therefore, it is possible to charge a storage battery by disengaging the third clutch C3 and using the driving force of the engine 10 to generate electricity by the motor generator 20 in this state.

Also, in the hybrid drive apparatus 1 according to this embodiment, the third clutch C3 is provided on the output shaft of the continuously variable transmission mechanism 40. According to this configuration, by disengaging the third clutch C3, it is possible to cut off transmission of power from the continuously variable transmission mechanism 40 to the drive wheels 60, 60 while keeping the continuously variable transmission mechanism 40 rotated by the power transmitted from the planetary gear mechanism 30. As a result, the continuously variable transmission mechanism 40 does not need to be controlled on the condition that the ratio (pulley ratio) of the continuously variable transmission mechanism 40 at the time of cutting off transmission of power to the drive wheels 60, 60 can be returned to the ratio used at the time of resuming transmission of power to the drive wheels next time. That is, it is possible to change the ratio of the continuously variable transmission mechanism 40 even while transmission of power to the drive wheels 60, 60 is cut off by disengaging the third clutch C3. Thus, even if the ratio at the time of resuming transmission of power to the drive wheels 60, 60 next time is a low speed ratio for hill-climbing driving or decelerating regeneration, the ratio of the continuously variable transmission mechanism 40 prior to cutting off transmission of power to the drive wheels 60, 60 can be set to an optimum ratio for the driving condition at that time. Therefore, it is possible to perform regeneration of decelerating energy or the like without affecting the drivability of the vehicle.

Also, it is unnecessary to supplement torque during low speed driving by the motor generator 20 in order to return the ratio of the continuously variable transmission mechanism 40 to a low speed ratio when resuming transmission of power to the drive wheels 60, 60 next time. Therefore, there is no need to secure spare capacity in the output of the motor generator 20 in consideration of the need to supplement torque, and hence it is possible to use the motor generator 20 with lower power and smaller size.

### Second Embodiment

Next, a second embodiment of the invention is described. In the description of the second embodiment and the corresponding drawings, component parts that are identical or equivalent to those in the first embodiment are denoted by the same symbols, and a detailed description of those parts is omitted. Also, matters other than those described below are the same as those in the first embodiment.

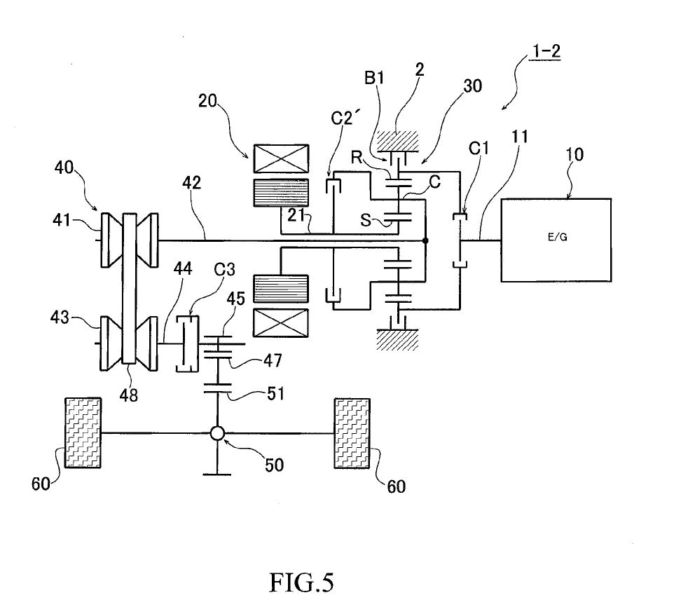

FIG. 5 is a skeleton diagram illustrating the configuration of a hybrid drive apparatus 1-2 according to the second embodiment of the invention. The hybrid drive apparatus 1-2 illustrated in FIG. 5 includes, instead of the second clutch C2 provided between the ring gear R and carrier C of the planetary gear mechanism 30 (between the output shaft 11 of the engine 10 and the input shaft 42 of the continuously variable transmission mechanism 40) in the hybrid drive apparatus 1 according to the first embodiment illustrated in FIG. 1, another clutch C2′ that is provided between the sun gear S and carrier C of the planetary gear mechanism 30 (between the output shaft 21 of the motor generator 20 and the input shaft 42 of the continuously variable transmission mechanism 40). The configuration of this hybrid drive apparatus is otherwise the same as that of the hybrid drive apparatus 1 according to the first embodiment. That is, in the hybrid drive apparatus 1-2 according to this embodiment, the output shaft 21 of the motor generator 20 is coupled to the sun gear S of the planetary gear mechanism 30, the output shaft 11 of the engine 10 is coupled to the ring gear R, and the input shaft 42 of the continuously variable transmission mechanism 40 is coupled to the carrier C. Further, the first clutch C1 is provided between the output shaft 11 of the engine 10 and the ring gear R of the planetary gear mechanism 30, the second clutch C2′ is provided between the carrier C and sun gear S of the the planetary gear mechanism 30, and the third clutch C3 is provided on the output shaft 44 (between the driven pulley 43 and the output gear 45) of the continuously variable transmission mechanism 40 which connects to the driven pulley 43.

In the hybrid drive apparatus 1 according to this embodiment as well, provision of the second clutch C2′ between the sun gear S and the carrier C of the planetary gear mechanism 30 results in smaller differential rotation (slipping velocity) of the friction material with disengaged second clutch C2′, in comparison to a clutch in the hybrid drive apparatus according to the related art which is provided between the ring gear and the sun gear of the planetary gear mechanism. Thus, friction loss in the second clutch C2′ can be reduced, thereby achieving a corresponding improvement in the power transmission efficiency of the hybrid drive apparatus 1-2.

### Third Embodiment

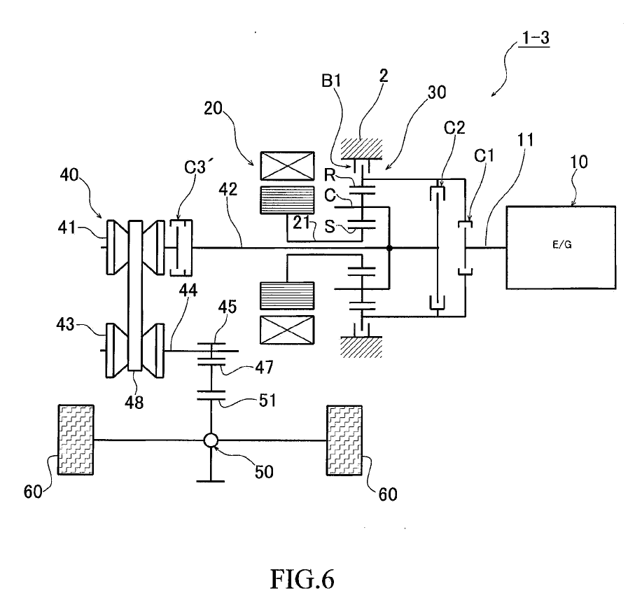

Next, a third embodiment of the invention is described. FIG. 6 is a skeleton diagram illustrating the configuration of a hybrid drive apparatus according to the third embodiment of the invention. A hybrid drive apparatus 1-3 according to the third embodiment illustrated in FIG. 6 includes, instead of the third clutch C3 provided on the output shaft (second rotating shaft) 44 of the continuously variable transmission mechanism 40 which connects to the driven pulley 43 in the hybrid drive apparatus 1 according to the first embodiment illustrated in FIG. 1, another third clutch C3′ that is provided on the input shaft (first rotating shaft) 42 of the continuously variable transmission mechanism 40 which connects to the driving pulley 41. The configuration of this hybrid drive apparatus is otherwise the same as that of the hybrid drive apparatus 1 according to the first embodiment.

In the hybrid drive apparatus 1-3 according to this embodiment, the third clutch C3′ is provided on the input shaft 42 of the continuously variable transmission mechanism 40. Thus, by disengaging the third clutch C3′, it is possible to limit the driving force (input torque) input to the belt-type continuously variable transmission mechanism 40. As a result, functional compensation such as slip compensation of the belt-type continuously variable transmission mechanism 40 is possible without complex control or estimation of the input torque to the belt-type continuously variable transmission mechanism 40.

While embodiments of the invention have been described above, the invention is not limited to the above-mentioned embodiments but various modifications are possible within the scope of the technical idea as defined in the claims, the specification, and the drawings. For example, the transmission mechanism included in the hybrid drive apparatus according to the invention is not limited to the belt-type continuously variable transmission mechanism 40 according to each of the above-mentioned embodiments but may be a transmission mechanism of another configuration.

What is claimed is:

1. A hybrid drive apparatus comprising:
an engine that generates power by combustion of fuel, and has an output shaft;
a motor generator that functions as an electric motor and a generator, and has a rotating shaft;
a planetary gear mechanism that has three elements, the three elements including a sun gear, a ring gear, and a carrier;
a transmission mechanism that has a first rotating shaft coupled to the planetary gear mechanism, and a second rotating shaft connecting to a drive wheel side, the transmission mechanism being configured to output a rotation input from one of the first rotating shaft and the second rotating shaft to the other one of the first rotating shaft and the second rotating shaft while changing a speed of the rotation,
the rotating shaft of the motor generator, the output shaft of the engine, and the first rotating shaft of the transmission mechanism being coupled to the sun gear, the ring gear, and the carrier, respectively, of the planetary gear mechanism;
a first clutch that can switch engagement/disengagement between the output shaft of the engine and the ring gear of the planetary gear mechanism; and
a second clutch that can switch engagement/disengagement between the carrier and the ring gear of the planetary gear mechanism, or between the carrier and the sun gear.

2. The hybrid drive apparatus according to claim 1, further comprising a third clutch that can switch engagement/disengagement on the first rotating shaft or the second rotating shaft of the transmission mechanism.

3. The hybrid drive apparatus according to claim 2, wherein:
the transmission mechanism is a belt-type continuously variable transmission mechanism, the belt-type continuously variable transmission mechanism including
a driving pulley that connects to the first rotating shaft,
a driven pulley that connects to the second rotating shaft, and
a belt that is run between the driving pulley and the driven pulley; and
the third clutch is provided on the first rotating shaft of the transmission mechanism.

4. The hybrid drive apparatus according to claim 2, wherein:
the transmission mechanism is a belt-type continuously variable transmission mechanism, the belt-type continuously variable transmission mechanism including
a driving pulley that connects to the first rotating shaft,
a driven pulley that connects to the second rotating shaft, and
a belt that is run between the driving pulley and the driven pulley; and
the third clutch is provided on the second rotating shaft of the transmission mechanism.
